(19) United States
(12) Patent Application Publication
(10) Pub. No.: US 2019/0178833 A1
(43) Pub. Date: Jun. 13, 2019

(54) POTENTIOMETRIC SENSOR FOR DETERMINING pH, AND METHOD FOR ESTABLISHING A CONNECTION BETWEEN A SHAFT TUBE AND A GLASS MEMBRANE OF A POTENTIOMETRIC SENSOR

(71) Applicant: Endress+Hauser Conducta GmbH+Co. KG, Gerlingen (DE)

(72) Inventors: Carsten Enderwitz, Dresden (DE); Jens Voigtländer, Waldheim (DE); Roland Zilly, Jahnsdorf (DE)

(21) Appl. No.: 16/217,251

(22) Filed: Dec. 12, 2018

(30) Foreign Application Priority Data
Dec. 12, 2017 (DE) 10 2017 129 634.4

(51) Int. Cl. G01N 27/36; G01N 27/38; G01N 27/416; C03B 19/01; B33Y 10/00; B33Y 80/00

(52) U.S. Cl. CPC G01N 27/36; G01N 27/38; B33Y 80/00; C03B 19/01; B33Y 10/00; G01N 27/4167

(57) ABSTRACT

A potentiometric sensor for determining pH, comprising a shaft tube and a glass membrane. The shaft tube and the glass membrane form a first chamber in which an inner electrolyte of the sensor and a discharge element of the sensor are positioned. The sensor also includes a reference element and a reference electrolyte outside the first chamber. The glass membrane and/or a transition region adjoining the glass membrane is produced by a generative process to form a connection between the shaft tube and the glass membrane of the sensor.

### CROSS-REFERENCE TO RELATED APPLICATION

The present application is related to and claims the priority benefit of German Patent Application No. 10 2017 129 634.4, filed on Dec. 12, 2017, the entire contents of which are incorporated herein by reference.

### TECHNICAL FIELD

The present disclosure relates to a potentiometric sensor for determining pH, and to a method for establishing a connection between a shaft tube and a glass membrane of the potentiometric sensor.

### BACKGROUND

Half-cells for determining pH are widely used and are well-known in a wide variety of designs. A corresponding glass electrode is, for example, known from DE 10 2013 114 745 A1. It describes a glass electrode with a shaft tube, glass membrane and electrode shaft made of a lead glass, or with a lead glass surface in segments.

However, material stresses may occur in the transition region due to the different glass materials of the shaft tube and the glass membrane.

### SUMMARY

A potentiometric sensor for determining pH according to the present disclosure comprises a shaft tube and a glass membrane, wherein the shaft tube and the glass membrane form a first chamber in which an inner electrolyte of the sensor and a discharge element of the sensor are positioned. The sensor also has a reference element and a reference electrolyte outside the first chamber.

The reference element and the reference electrolyte may, for example, be positioned in an annular chamber positioned between an outside electrode shaft and the shaft tube.

The glass membrane and/or a transition region adjoining the glass membrane may be produced by a generative process. By using the generative process, the application can be designed such that diffusion effects of the two kinds of glass among one another are reduced and material stresses are decreased.

The glass produced by the generative process, including the sensor membrane or the transition region, may be translucent or opaque.

The glass membrane and/or the transition region may have a color coding, for example, for identification of the type of sensor.

The glass membrane and/or the adjoining transition region may be formed by layer-by-layer application of powdered material to an annular face of the shaft tube and subsequent laser treatment. A phase boundary between the transition region and the glass produced by the generative process can be designed as visible in this case.

The transition region formed by the generative process may be formed as a projection which projects radially out of the outer wall of the shaft tube. As a result, the bond of the glass membrane to the liquid glass material can be created during production by means of the larger and dimensionally stable contact surface.

The transition region formed by the generative process can serve as an adjustment region of the thermal alternating temperature resistance and/or the coefficient of thermal expansion between the shaft tube and the glass membrane. Appropriate adjustments of the applied glass mixture to the materials of the shaft tube and the glass membrane can be made.

The glass composition of the transition region along the longitudinal axis of the sensor can be selected such that a gradient of the alternating temperature resistance and/or the coefficient of thermal expansion is present in the transition region between the shaft tube and the glass membrane. For this purpose, the respective applied layers can be varied, for example with regard to some or all components of the glass composition within a range between the composition of the shaft tube and glass membrane.

The glass membrane produced by the generative process may extend collinearly to the tube wall of the shaft tube, which is arranged at least on one side next to the glass membrane. This allows for improved accessibility of the glass membrane, for example for better cleanability but also for other operations, such as, for example calibration possibilities.

A portion of the shaft tube may be formed as a spacer having a spacer with a circular or an ellipsoidal cross-section in some areas. The spacer may be produced by the generative process in order to maintain high dimensional stability.

Typically, shaft tubes of glass sensors are made of glass, as can also be realized in a variant of the present disclosure. However, due to the increasingly more difficult availability of suitable glass materials for sensor construction, the shaft tube may be made of a ceramic material. The higher material stresses between the shaft tube and the glass membrane may be avoided by the transition region applied according to the present disclosure and/or by the glass membrane produced according to the present disclosure.

A method according to the present disclosure for establishing a connection between a shaft tube and a pH-sensitive glass membrane of a potentiometric sensor for determining pH, according to the present disclosure, comprises steps of providing a shaft tube, applying a transition region of glass material to an annular face of the shaft tube by a generative process, and applying a glass membrane to the transition region.

Material stresses in the region of the glass membrane and/or in the transition region to the shaft tube may be reduced by using the method.

The step of applying the glass membrane to the transition region can also take place by a generative process.

The present disclosure is described in more detail below with reference to an exemplary embodiment and with the assistance of the accompanying figures. The exemplary embodiment is in no way to be understood as limiting the subject matter of the present disclosure. In particular, several individual features of the following design variants of potentiometric sensors according to the present disclosure are also to be understood separately and detached from the exemplary embodiment in the context of the present disclosure. For example, the present disclosure is not limited to a sensor having two chambers for inner and reference electrolytes; instead the reference electrolyte may also be positioned in a dropwise manner around the reference electrode.

### BRIEF DESCRIPTION OF THE DRAWINGS

FIG. 1 shows a pH sensor designed as a potentiometric single-rod measuring chain, comprising a half-cell according to the present disclosure;

FIG. 2 shows a first variant of a shaft tube of a sensor according to the present disclosure with an attached transition region;

FIG. 3 shows a second variant of a shaft tube of a sensor according to the present disclosure with an attached transition region; and

FIG. 4 shows a third variant of a shaft tube of a sensor according to the present disclosure with an integrated pH-sensitive glass membrane.

### DETAILED DESCRIPTION

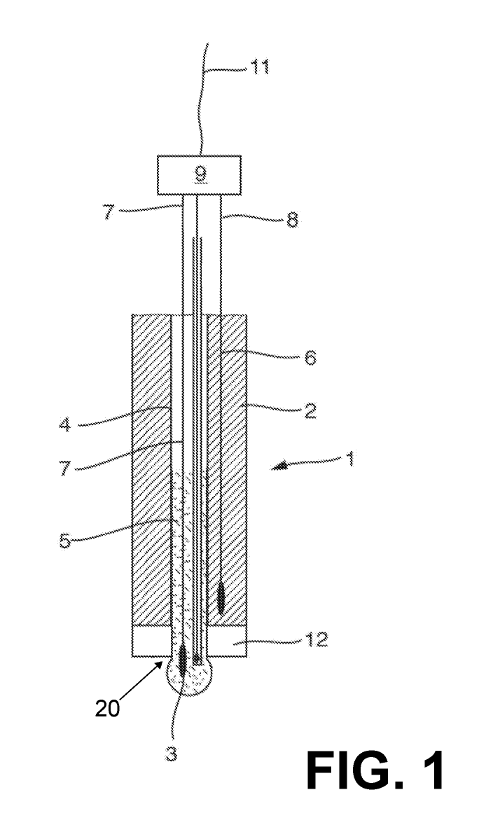

FIG. 1 shows a potentiometric sensor 1 for pH measurement, which is designed as a single-rod measuring chain. The sensor 1 comprises a tubular outside electrode shaft 2 which is connected in a lower section to an inner shaft tube 4. The lower section of the electrode shank 2 is connected to a pH-sensitive glass membrane 3.

The inner shaft tube 4 and the glass membrane 3 form a first chamber in which an inner electrolyte 5, e.g., a buffer solution, is accommodated. A discharge element 7 that is connected to a measuring circuit 9 in an electrically conductive manner is immersed in the inner electrolyte 5. Between the inner shaft tube 4 and the electrode shaft 2, an annular chamber is formed in which a reference electrolyte 6 is contained, which is in contact with a measuring medium surrounding the front end of the sensor 1 via a diaphragm 12 serving as an electrochemical crossover.

The reference electrolyte 6 can, for example, be a highly concentrated 3 molar, KCl solution. A reference element 8 that is connected to the measuring circuit 9 in an electrically conductive manner is immersed in the reference electrolyte 6. In the present example, the reference element 8 and the discharge element 7 are designed as chloridated silver wires.

At its rear end opposite the end portion connected to the glass membrane 3, the tubular outside electrode shaft 2 and the inner shaft tube 4 are closed in a liquid-tight manner. The measuring circuit 9 is accommodated in an electronics housing attached to the rear side of the electrode shaft 2. It is designed to detect a difference in potential between the discharge element 7 and the reference element 9 and to generate a measuring signal that represents this difference in potential. The measuring signal can be output via the cable connection 11 to a higher-level data processing unit (not shown in FIG. 1), e.g., a transmitter, transducer, computer, or programmable logic controller.

The electrode shaft 2 and the inner shaft tube 4 consist of the same glass in the present example.

The pH-sensitive glass from which the glass membrane 3 is formed consists of a multicomponent glass comprising a predetermined lithium oxide content.

The inner shaft tube 4 is connected to the glass membrane 3 in a transition region 20. This is typically done by immersing the shaft tube 4 into a liquid glass melt and subsequently molding the glass melt into a spherical shape.

However, sharp edges can cause temperature stresses up to cracks in the transition region 20 between the shaft tube 4 and the glass membrane 3.

According to the present disclosure, the transition region 20 between the shaft tube 4 and the glass membrane 3 may be formed using a generative production method.

Generative production methods for glass are known, for example, from the series of papers “Werkstofftechnik aktuell” of the Technical University of Imenau, vol. 16, entitled “Generative Fertigung von Sinterglaskörpern für Glasdurchführungen durch 3D-Drucken” by Katja Nicolai.

In the present case, the transition region 20 can be applied to the terminal annular face of the shaft tube 4 after it is provided. The glass membrane 3 can subsequently be applied to this transition region 20.

The material of the transition region 20 can preferably be varied in such a way that an adjustment of the temperature change resistance (according to EN ISO 7459:2004) and/or the coefficient of thermal expansion (determination according to DIN ISO 7991 in the current version at the time of December 2017) between the shaft tube 4 and the pH-sensitive glass of the glass membrane 3 is ensured.

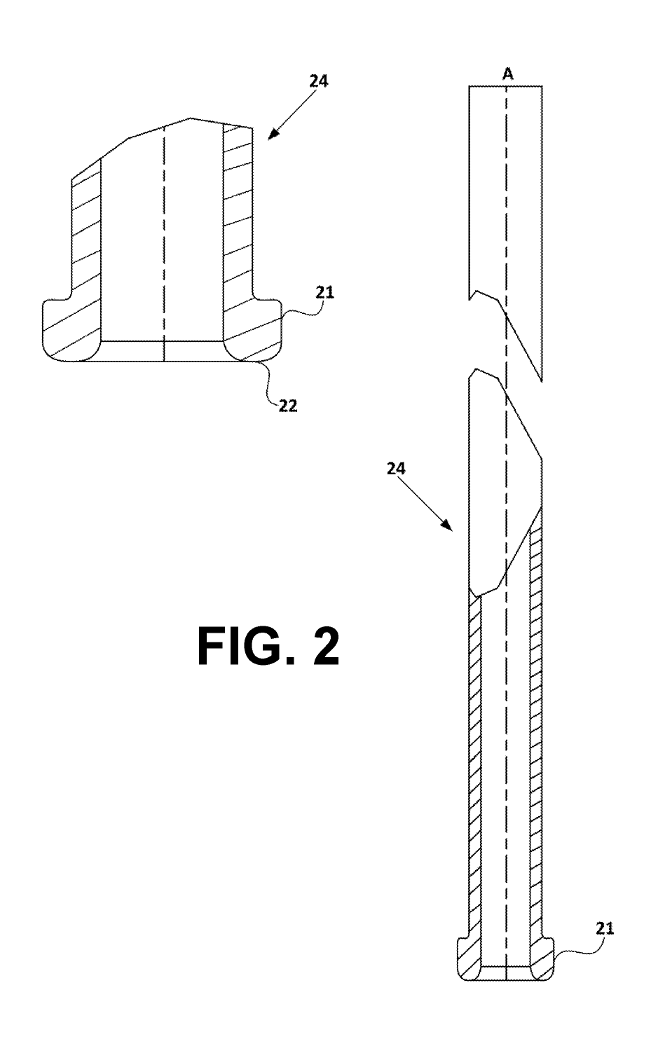

Individual applications for using the generative process in the production of a potentiometric sensor for determining pH are shown in detail in FIGS. 2-4.

Referring also back to FIG. 1, FIG. 2 shows in detail a variant of an inner shaft tube 24 prior to connection to the remaining parts of the potentiometric sensor 1. A projection 21 is formed at the end of the shaft tube 24 and serves for connection to the glass membrane 3. In comparison to the predominantly prevailing wall thickness of the shaft tube 24, this projection 21 preferably has more than twice the wall thickness.

The extension of the projection 21 as part of the shaft tube preferably corresponds to at least twice the wall thickness of the predominantly prevailing wall thickness of the shaft tube 24.

The projection 21 has a face 22 for wetting with the pH-sensitive glass. This face 22 is rounded, whereby the risk of material stresses along the annular face is advantageously further reduced.

The projection 21 itself can be applied by a generative process, or an additional connection region may be applied to the projection by means of the generative process.

A generative process can be carried out, for example, in such a way that particulate glass material is applied layer by layer to the shaft tube 24 and is subsequently melted by a laser. As a result, glass material can be applied layer by layer to the annular face of the shaft tube 24. Since the layers cool to some extent after their application, diffusion effects between the glass of the shaft tube 24 and the pH-sensitive glass are reduced, so that the pH-sensitive glass is more homogeneous in its composition.

Furthermore, the glass composition of the individual applied layers can be adjusted to the material of the shaft tube 24 and to the material of the pH-sensitive glass, for example by varying one or more components between the individual applied layers. This adjustment may preferably be a gradient, for example a linear gradient, so that the glass composition of each individual layer is changed according to the gradient.

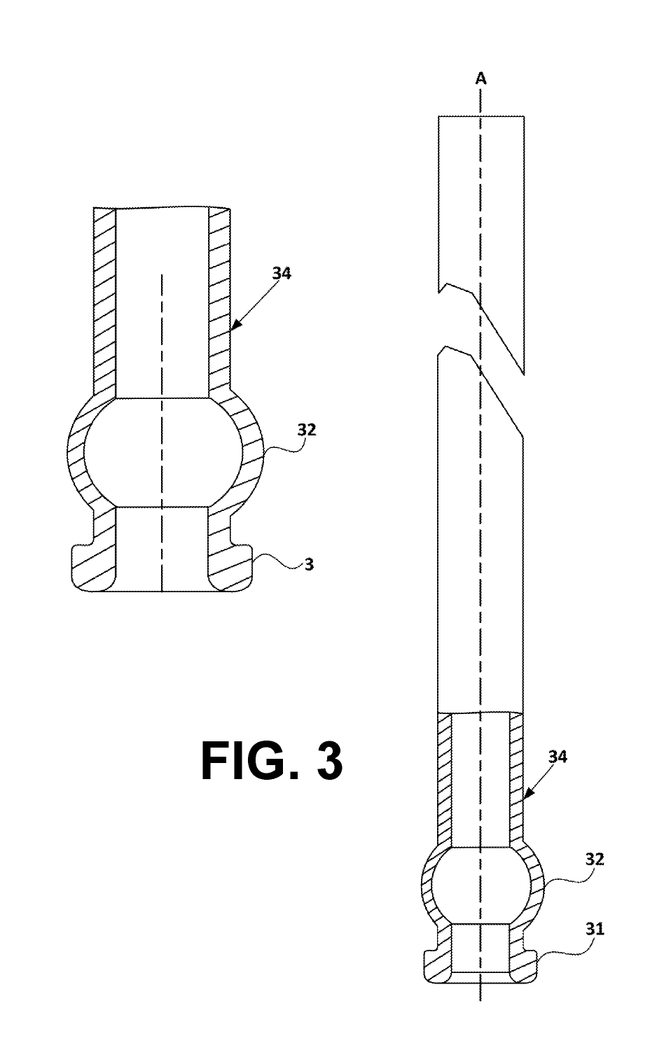

FIG. 3 shows another design variant of a shaft tube 34. In this case, on a medium-side end portion, the shaft tube 34 has a spacer 32 with a circular or ellipsoidal cross-section which is formed by a wall of the shaft tube 34.

This spacer 32 serves for spacing the outside electrode shaft. Since a high dimensional stability is required for the spacer design, the spacer 32 can advantageously also be applied by a generative process to an annular face of the shaft tube 34 which is not shown in more detail.

In FIG. 3, the shaft tube 34 also has at its end a projection 31 for connecting the pH-sensitive glass. The projection 31 and the spacer 32 can preferably both be realized by the same generative process.

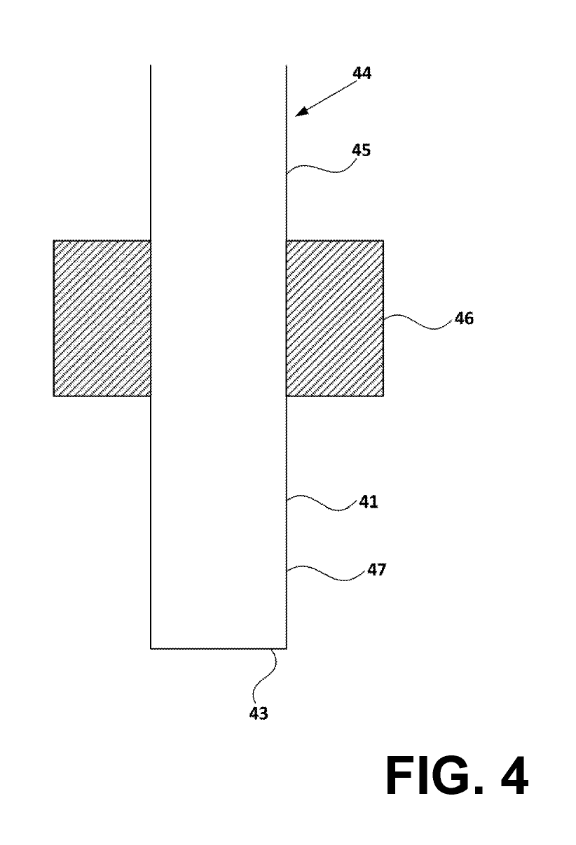

FIG. 4 shows a shaft tube 44 of a potentiometric sensor of another design variant of the present disclosure. In this case, the pH sensor glass is applied as a tube section 31 of the shaft tube 44 by a generative process.

In a subsequent section, the shaft tube 44 is closed along a terminal face 43 which covers the tube cross-section at the end and closes it in the direction of the medium. In this design variant, the pH-sensitive glass thus does not form the terminal end of the shaft tube 44 but rather a cylindrical tube wall segment, which is collinear to the lateral surface 45 of the shaft tube 44.

This variant of the shaft tube 44 and thus also of the sensor can be cleaned automatically. e FIG. 4 shows a wiper 46 which can move over the sensor surface and thereby clean deposits from it. Alternatively or additionally, the wiper 46 can also have a sensor system for determining the sensor state, for example a turbidity sensor for measuring the degree of soiling of the pH-sensitive glass.

Alternatively or in addition to the wiper 46, a unit movable relatively to the pH-sensitive glass can also be provided as a calibration unit, with which calibration of the sensor can take place. For this purpose, a unit with a calibration solution, e.g., with a salt solution, can be arranged outside of the otherwise tubular shaft tube 44 and can be moved temporarily during a calibration period over the pH-sensitive glass to carry out a calibration, and does not cover the pH-sensitive glass during the sensor measuring mode. As with the wiper 46, in particular, a design variant with a tubular sensor shape with a pH-sensitive glass integrated into the lateral surface of the tube 44 is particularly advantageous in this case.

The transition region produced by the generative process, or the pH-sensitive glass produced by the generative process, can be colored by adding at least an additive to the glass material applied in the generative process. A preferred additive may, for example, be a salt and/or a metal oxide of a transition metal, for example cobalt chloride. Combinations of one of the aforementioned compounds with other inorganic compounds, such as for example in the case of gold purple, are also conceivable.

The colored transition region may represent a color coding for the field of application of the pH sensors, for example in the food sector, in highly corrosive media, in hot media and the like. The color coding can also be helpful in production itself, for example to protect against confusion in the case of membrane glasses of the same color.

As an alternative to the connection between a glass shaft tube to a sensor membrane made of a pH-sensitive glass, the realization of the transition region by a generative process also enables the use of other materials, in particular the use of ceramic, as shaft tube material. A shaft tube can thus be produced in sections or completely from ceramic with an adjoining sensor membrane made of pH-sensitive glass. At least at the end toward the sensor membrane, the shaft tube can be made of ceramic material. However, another transition region which was produced by the generative process can be arranged between this ceramic material and the glass membrane. This transition region can, but need not necessarily, be assigned to the shaft tube.

A ceramic which contains zirconium oxide and/or aluminum oxide can, for example, be used as ceramic, which inter alia is non-toxic, so that the pH half-cell can also be discarded more easily in case of inadvertent destruction and can, where applicable, be used in food applications.

1. A potentiometric sensor for determining pH, comprising:
a shaft tube and a glass membrane, wherein the shaft tube and the glass membrane form a first chamber in which an inner electrolyte of the sensor and a discharge element of the sensor are positioned;
a reference element and a reference electrolyte outside the first chamber;
wherein the glass membrane and/or a transition region adjoining the glass membrane is formed by a generative process.

2. The potentiometric sensor of claim 1, wherein the glass membrane and/or the transition region has a color coding.

3. The potentiometric sensor of claim 1, wherein the glass membrane and/or the transition region is formed by layer-by-layer application of powdered material to an annular face of the shaft tube, and subsequent laser treatment.

4. The potentiometric sensor of claim 1, wherein the transition region formed by the generative process is formed as a projection which projects radially out of a wall of the shaft tube.

5. The potentiometric sensor of claim 1, wherein the transition region formed by the generative process is designed as an adjustment region of thermal alternating temperature resistance and/or a coefficient of thermal expansion between the shaft tube and the glass membrane.

6. The potentiometric sensor of claim 1, wherein a glass composition of the transition region along a longitudinal axis of the sensor is selected such that a gradient of an alternating temperature resistance and/or a coefficient of thermal expansion is present in the transition region between the shaft tube and the glass membrane.

7. The potentiometric sensor of claim 1, wherein the glass membrane produced by the generative process extends collinearly to a tube wall of the shaft tube which is positioned at least on one side next to the glass membrane.

8. The potentiometric sensor of claim 1, wherein a section of the shaft tube is designed as a spacer having a circular or ellipsoidal cross-section, wherein the spacer is produced by the generative process.

9. The potentiometric sensor of claim 1, wherein the shaft tube includes ceramic.

10. The potentiometric sensor of claim 1, wherein the sensor has a wiper, a sensor unit for detecting a state of the sensor and/or a calibration unit for calibrating the sensor, wherein the wiper, the sensor unit and/or the calibration unit are arranged in a linearly movable manner along a longitudinal axis of the shaft tube and over the glass membrane.

11. A method for establishing a connection between a shaft tube and a pH-sensitive glass membrane of a potentiometric sensor for determining pH, including steps of:
providing the shaft tube;
applying a transition region of glass material to an annular face of the shaft tube via a generative process; and
applying the pH-sensitive glass membrane to the transition region.

12. The method of claim 11, further including applying the pH-sensitive glass membrane via a generative process.

13. The method of claim 11, further including forming the glass membrane and/or the transition region via layer-by-layer application of a powdered material to an annular face of the shaft tube, and applying a laser treatment.

14. The method of claim 11, further including forming the transition region via the generative process as a projection projecting radially out of a wall of the shaft tube.

15. The method of claim 11, wherein forming the transition region includes forming the transition region as an adjustment region of thermal alternating temperature resistance and/or a coefficient of thermal expansion between the shaft tube and the glass membrane.

16. The method of claim 11, further including selecting a glass composition of the transition region along a longitudinal axis of the sensor such that a gradient expansion is present in the transition region between the shaft tube and the glass membrane.

17. The method of claim 11, further including positioning the glass membrane produced by the generative process collinearly with a tube wall of the shaft tube which is arranged at least on one side next to the glass membrane.

18. The method of claim 11, further including configuring a section of the shaft tube as a spacer having a circular or ellipsoidal cross-section in some areas, wherein the spacer is produced by the generative process.

19. The method of claim 11, further including forming the shaft tube using ceramic.

20. The method of claim 11, further including positioning a wiper, a sensor unit for detecting a state of the censor and/or a calibration unit for calibrating the sensor such that the wiper, the sensor unit and/or the calibration unit is linearly movable along a longitudinal axis of the shaft tube and over the glass membrane.
